(19) United States
(12) Patent Application Publication
(10) Pub. No.: US 2022/0244901 A1
(43) Pub. Date: Aug. 4, 2022

(54) Tiling Display System

(71) Applicant: Apple Inc., Cupertino, CA (US)

(72) Inventors: Yang Li, San Jose, CA (US); Cheng Chen, San Jose, CA (US); Jiaying Wu, San Jose, CA (US); Kuan H. Lu, Santa Clara, CA (US); Yi-Pai Huang, Cupertino, CA (US); Yung-Yu Hsu, San Jose, CA (US)

(21) Appl. No.: 17/575,793

(22) Filed: Jan. 14, 2022

Related U.S. Application Data
(60) Provisional application No. 63/143,182, filed on Jan. 29, 2021.

(51) Int. Cl. G06F 3/14; G09F 9/302

(52) U.S. Cl. CPC G06F 3/1446; G09F 9/3026

(57) ABSTRACT

A tiling display system has multiple display panels. The display panels may be positioned by positioners that are coupled to the display panels. In an untiled operating mode, the display panels of the tiling display system are moved apart. In this mode, each display panel can display different content such as different static images of artwork. In a tiled operating mode, the display panels of the tiling system are moved together to form a single display that displays a single still or moving image. Components on the backs of the display panels and/or along the edges of the display panels may be used to facilitate panel-to-panel alignment, to help couple adjacent panels together, and to support the transfer of power and/or data signals among the panels. The components may include optical and/or electrical alignment sensors, magnets for alignment and coupling, and transmitters and receivers for transmitting and receiving signals.

This application claims the benefit of provisional patent application No. 63/143,182, filed Jan. 29, 2021, which is hereby incorporated by reference herein in its entirety.

### FIELD

This relates generally to electronic devices, and, more particularly, to electronic devices with displays.

### BACKGROUND

Displays are used to present visual content to users. In some applications, large display size is desirable. For example, it is sometimes desirable to present television content on large displays to facilitate viewing by large groups of people. At the same time, large devices can be visually intrusive.

### SUMMARY

A reconfigurable tiling display system has multiple display panels. The display panels may be, for example, organic light-emitting diode display panels, other panels with arrays of light-emitting diodes, liquid crystal display panels, or other display panels. The display panels may be used in displaying static artwork, video, and/or other image content.

The display panels may be positioned by positioners that are coupled to the display panels. The positioners may be robotic arms or other electrically controlled positioners. Each positioner may be used to mount a respective display panel to a wall or other support structure.

Display panels in a tiling display system may all have the same size and shape and/or different display panels in the system may have different sizes and shapes. The positioners may be used to move the panels in response to user commands. This allows the display system to be operated in either a tiled display mode or an untiled display mode.

In the untiled mode, the display panels of the tiling display system are moved apart. In this mode, each display panel can display different content such as different static images.

In a tiled operating mode, the display panels of the tiling system are moved together to form a single display that displays a single still or moving image. In this mode the display panels operate together.

Components on the backs of the display panels and/or along the edges of the display panels may be used to facilitate panel-to-panel alignment, to help couple adjacent panels together, and to support the transfer of power and/or data signals among the panels (e.g., when the panels are coupled together in the tiled display mode). The components may include optical and/or electrical alignment sensors, magnets for alignment and coupling, and transmitters and receivers for transmitting and receiving signals.

### BRIEF DESCRIPTION OF THE DRAWINGS

FIG. 1 is a schematic diagram of an illustrative tiling display system in accordance with an embodiment.

FIG. 2 is a front view of an illustrative tiling display system being operated in an untiled mode accordance with an embodiment.

FIG. 3 is a front view of the illustrative tiling display system of FIG. 2 being operated in a tiled mode in accordance with an embodiment.

FIGS. 4, 5, 6, and 7 are front views of illustrative tiling display systems in accordance with embodiments.

FIG. 8 is a cross-sectional side view of an illustrative display panel for a tiling display system in accordance with an embodiment.

FIGS. 9, 10, and 11 are diagrams showing signal routing paths for illustrative tiling display systems in accordance with embodiments.

FIGS. 12 and 13 are circuit diagrams of illustrative tiling display systems in accordance with an embodiment.

FIG. 14 is a diagram of an illustrative tiling display system during alignment operations in accordance with an embodiment.

FIG. 15 is a front view of a portion of an illustrative tiling display system having components for facilitating alignment operations accordance with an embodiment.

FIG. 16 is a diagram of a portion of an illustrative tiling display system in which components in adjacent panels are used for facilitating signal sharing, panel alignment, and/or panel coupling in accordance with an embodiment.

FIG. 17 is a front view of an illustrative display panel for a tiling display system in accordance with an embodiment.

FIGS. 18, 19, and 20 are front views of illustrative display panel components for facilitating signal sharing, alignment, and/or coupling in accordance with embodiments.

### DETAILED DESCRIPTION

A tiled display system may have display panels that can be operated in tiled and untiled display modes. In the untiled display mode, the display panels may be physically separated from each other and may display content independently. As an example, each display panel in a system may be placed in a separate location on a wall or other support structure and each display panel may display a separate still image. In this untiled mode of operation, each display panel may, as an example, be used to display a different work of art. When it is desired to form a larger display, the display panels in the system may be coupled together in a tiled fashion to form a single larger display. A still or moving image that spans the entire display may be displayed for viewing. In this tiled display mode, the display panels are used collectively, each forming an active tile in the display. The enlarged size of the display formed from the tiled display panels in the system may be helpful in displaying video content to a group of viewers.

Display panels may be positioned manually and/or may be positioned using positioners. Electrically adjusted positioners in a tiled display system may, as an example, be controlled using remote-control commands, voice commands, and/or other user input.

When display panels are combined to form an enlarged display area, magnets and/or other attachment structures may be used to help align and couple display panels to each other. Sensors may be used in making measurements that are used when aligning panels. Circuitry in the display panel system may be used to help coupled display panels in a tiled display system share power and/or data signals. For example, serial and/or parallel communications circuits may be used to distribute display signals to display panels in series and/or in parallel. Serial and/or parallel communications circuitry may also be used in conveying touch sensor signals and/or other sensor signals among panels in the system.

The display panels in the tiled display system may be formed from arrays of light-emitting diode pixels, liquid crystal pixels, or other pixels. For example, a system may have organic light-emitting diode displays or displays formed from arrays of micro-light-emitting diodes (e.g., diodes formed from crystalline semiconductor dies).

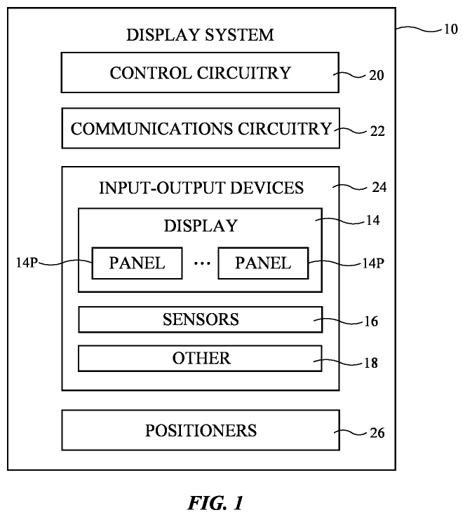

A schematic diagram of an illustrative tiled display system is shown in FIG. 1. Display system 10 includes multiple display panels 14P (sometimes referred to as displays, display devices, display system tiles, display tiles, tiles, pixel array tiles, pixel arrays, etc.). Display panels 14P may be moved relative to each other and may be operated independently (e.g., when panels 14P are separated from each other, sometimes referred to as an untiled display mode or untiled mode) or may be operated collectively to form a unified tiled display such as display 14 (e.g., when panels 14P are coupled to each other so that each panel 14P forms a respective tile in display 14). If desired, each panel 14P may be included in a separate electronic device that is optionally operated independently from other devices. For example, each panel 14P may be capable of serving as a free-standing display. In some configurations, panels 14P are part of electronic devices such as tablet computers, desktop computers, cellular telephones, televisions, and/or other electronic devices. In other configurations, each panel 14P operates primarily or exclusively as a display device that receives content primarily or exclusively from external sources. In general, panels 14P may be included in any suitable electronic equipment and/or any suitable housings. Arrangements in which panels 14P are separately housed display devices with rectangular outlines or other suitable shapes that allow panels 14P to serve as tiles in display 14 (e.g., when system 10 is operated in the tiled mode) are sometimes be described herein as an example.

System 10 may include control circuitry 20. Control circuitry 20 may include storage and processing circuitry for supporting the operation of system 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, display driver circuitry, etc. Control circuitry 20 may include circuitry that is shared among multiple panels 14P and/or may include circuits that are primarily or exclusively used in individual panels 14P (e.g., panel-specific circuits such as display driver circuits in each panel or touch sensor control circuits in each panel). During operation, control circuitry 20 may use display 14 (e.g., multiple tiled panels 14P) and/or individual panels 14P to provide a user with visual output. Control circuitry 20 may also use other output devices to provide a user with other types of output (e.g., audio output, haptic output, etc.). Control circuitry 20 may process sensor signals and other input (e.g., touch sensor input gathered from touch sensors in panels 14P, light sensor input and other sensor input from panels 14P, etc.).

To support communications between panels 14P of system 10 and/or between the circuitry of system 10 and external equipment, control circuitry 20 may include using communications circuitry 22. Circuitry 22 may include antennas, radio-frequency transceiver circuitry (wireless transceiver circuitry), and other wireless communications circuitry and/or wired communications circuitry (e.g., transmitters and receivers for transmitting and receiving analog and/or digital signals over transmission line paths, digital signal busses, and other signal paths). Circuitry 22, which may sometimes be referred to as control circuitry and/or control and communications circuitry, may support bidirectional wireless communications between the components of system 10 and/or between system 10 and external equipment over a wireless link (e.g., circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a wireless link operating at a frequency between 6 GHz and 300 GHz, a 60 GHz link, or other millimeter wave link, cellular telephone link, wireless local area network link, personal area network communications link, or other wireless communications link. System 10 may, if desired, include power circuits for transmitting and/or receiving wired and/or wireless power and may include batteries or other energy storage devices. For example, panels 14P and/or other portions of system 10 may include coils and rectifiers to receive wireless power.

Panels 14P and/or other portions of system 10 may include input-output devices such as input-output devices 24. For example, each panel 14P may include one or more input-output devices. Input-output devices 24 may be used in gathering user input, in gathering information on the environment surrounding the user, and/or in providing a user with output. Devices 24 may include pixel arrays (e.g., each panel 14P may have an array of pixels for displaying an image). Each display panel 14P may, as an example, include an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display device.

Sensors 16 in input-output devices 24 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping an array of pixels in a display panel, and/or a touch sensor that forms a button, trackpad, or other input device not associated with a display), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In some arrangements, system 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc. Each panel 14P in system 10 may have a respective set of sensors 16 and/or sensors 16 may be shared by multiple panels 14P in system 10.

If desired, system 10 may include additional components (see, e.g., other devices 18 in input-output devices 24). The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. System 10 may also include a battery or other energy storage device, connector ports for supporting wired communication with ancillary equipment and for receiving wired power, and other circuitry. These resources may be shared by panels 14P in system 10 or each panel 14P may have a respective set of such additional components.

During operation of system 10, a user may selectively place system 10 in a tiled operating mode or an untiled operating mode. Mode adjustment commands may be received by input-output devices 24 from a user (e.g., control circuitry 20 may use input-output devices 24 to gather user input to adjust the operating mode of system 10). This user input may include remote control commands, voice commands, button press input, touch input, gesture input, and/or other user input. In response to receiving a user mode adjustment command, control circuitry 20 can control positioners 26 (sometimes referred to as display panel positioners, motors, actuators, robotic positioners, etc.) and other resources in system 10 to move panels 14P together or apart and to adjust the operation of each panel 14P so that panels 14P work together or separately. In the untiled operating mode, positioners 26 may be used to move respective display panels 14P apart (or the user may manually separate panels 14P). In the tiled operating mode, positioners 26 (or manual positioning) may be used to join display panels 14P together in a tiled fashion to form a combined display (e.g., display 14). Panels 14P may all have the same shape and size (footprint when viewed from the front) or may have different shapes and sizes. For example, panels 14P may have rectangular outlines or outlines of other shapes and these outlines may have the same aspect ratios and sizes and/or may have one or more different aspect ratios and/or sizes.

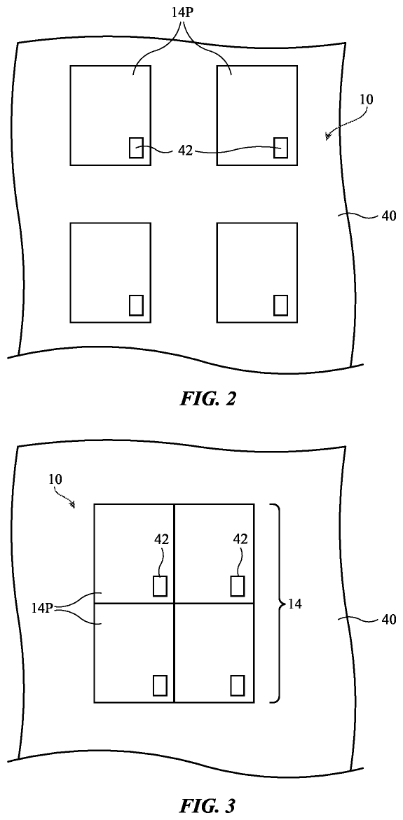

Consider, as an example, display system 10 of FIGS. 2 and 3, in which four display panels 14P are being used. In the illustrative scenario of FIG. 2, system 10 is being operated in an untiled mode in which display panels 14P have been separated. Panels 14P may be supported on a wall, stand, table top, floor, or other support structure such as support structure 40. Each panel 14P may have resources 42 (e.g., respective portions of control circuitry 20, communications circuitry 22, input-output devices 24, and/or positioners 26 of FIG. 1) and/or a set of resources 42 may be shared by multiple panels 14P. Resources 42 may include, for example, a respective ambient light sensor for each panel 14P, a two-dimensional capacitive touch sensor or other touch sensor for each panels 14P, one or more other sensors 16 for each panel 14P, etc. Resources 42 may also include panel-specific display driver circuitry, panel-specific communications circuits, etc. By providing each panel 14P with its own resources, panels 14P can operate separately. For example, each panel 14P may be individually turned on or off, may be used to display different content, etc. As an example, in the untiled mode of FIG. 2, some of panels 14P may be turned off, other panels 14P may be turned on, each panel 14P that is turned on may be displaying different content, and some of the displayed content may include static image content while other of the displayed content may include moving image content (e.g., video). In the untiled mode, for example, each display panel may display a static or moving image stored locally in storage in that panel or may display a still or moving image received wirelessly or over a wired path from a data source elsewhere in system 10.

When a user desires to combine panels 14P to create a larger display, the user may supply system 10 with a command that causes positioners 26 to move panels 14P together, as shown in FIG. 3. In the illustrative scenario of FIG. 3, panels 14P have been coupled together to from a single display (display 14) with a rectangular outline or other suitable outline and a size that is larger than each individual panel 14P. Different content may be displayed on different portions of display 14 or a single still or moving image may be displayed across the entire surface of display 14 (e.g., panels 14P may serve as tiles that are operated collectively to form an enlarged display area for display 14).

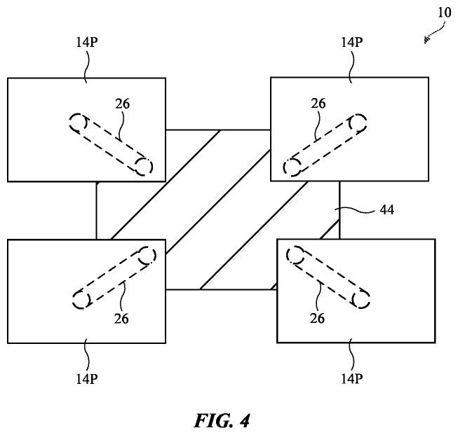

Each display panel 14P may have a respective positioner 26 (e.g., an individual motor or other actuator, a positioner formed by a set of gears or other positioning mechanism that can move that panel 14P, a robotic arm, etc.). The position and/or other structures for each panel 14P may be used in attaching that panel 14P to support structure 40. Support structure 40 may be a wall of a building, a piece of furniture, a floor, or other support structure. Configurations in which structure 40 is a wall may sometimes be described herein as an example. If desired, a supporting plate or other shared support member such as support plate 44 of FIG. 4 may be shared between panels 14P in system 10. As shown in FIG. 4, a respective positioner 26 (e.g., a robotic arm controlled by control circuitry 20 in response to user input) may be coupled between each panel 14P and a supporting member such as support plate 44. In this type of configuration, plate 44 (or other shared support structure) may be attached to a wall or other support structure such as support structure 40 of FIGS. 2 and 3, so that each panel 14P does not need to be attached directly to the wall.

There are four panels 14P in the illustrative systems of FIGS. 2, 3, and 4. In general, system 10 may have any suitable number of panels 14P (e.g., at least two, at least four, at least six, at least ten, at least 20, at least 40, fewer than 1000, fewer than 300, fewer than 100, fewer than 30, fewer than ten, 2-20, 2-10, 4-20, 4-16, etc.). In the tiled display mode, display 14 may have N×M panels, where N and M may have values of 1-50, 1-10, 2-6, 2-15, 2-4, at least 2, at least 4, at least 8, less than 100, less than 25, less than 10, less than 8, less than 6, less than 5, or other suitable numbers. The aspect ratio of display 14 may be wide and short, wide and tall, narrow and tall, etc. For example, display 14 may have panels 14P in a 2×2 arrangement, a 2×4 arrangement, a 3×9 arrangement, a 1×5 arrangement, a 5×1 arrangement, or any other suitable tiling pattern.

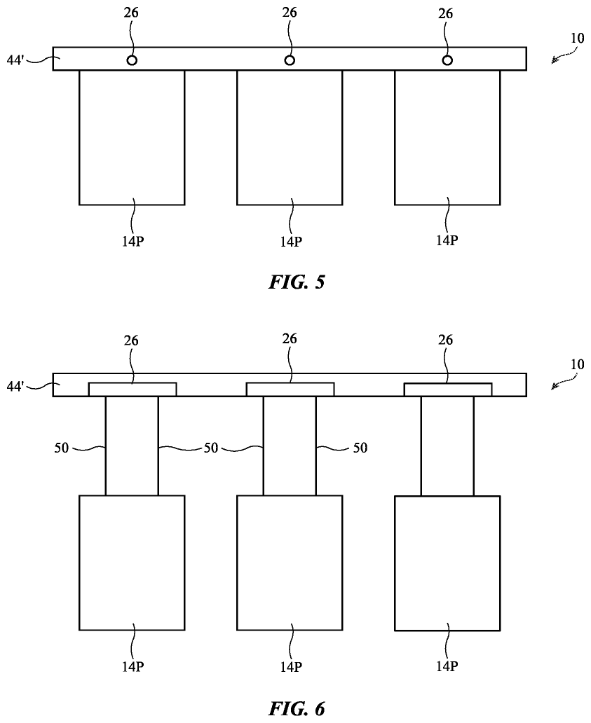

FIG. 5 shows how panels 14P may be positioned by respective positioners 26 that are coupled between respective panels 14P and an elongated plate such as supporting bar 44′ (e.g., an elongated rail or other horizontally extended support that may be mounted to a wall or other structure). In the example of FIG. 6, vertical supports 50 (e.g., cables or rods) are being used to couple respective panes 14P to positioners 26. Each positioner 26 is used to move a respective panel 14P relative to bar 44′ (e.g., by moving along a track in bar 44′, etc.). Bar 44′ may be coupled to a picture rail or other structure on a wall or other support (as an example). In the configurations of FIGS. 5 and 6, system 10 is operating in an untiled mode in which panels 14P have been separated from each other. In this mode, each panel 14P may display a separate still or moving image, may be turned off, and/or may otherwise be independently adjusted. When it is desired to operate system 10 in the tiled display mode, positioners 26 are used to move panels 14P together until each panel 14P is resting directly against its neighbors with little or no gap (e.g., no visible gap) between the pixels of adjacent panels. This allows panels 14P to be used collectively to form an enlarged display (e.g., display 14) that displays visual content (e.g., a still or moving image) for a user.

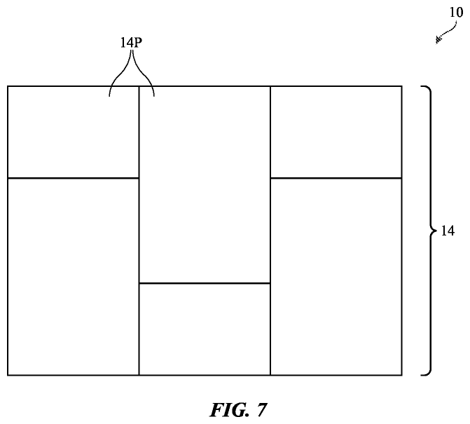

If desired, system 10 may include panels 14P of different sizes. There may, as an example, be two or more different sizes of display panel in system 10. FIG. 7 is a front view of system 10 in an illustrative configuration in which display 14 has been formed from three smaller panels and three larger panels. In the tiled mode of FIG. 7, panels 14P have been joined together to form a unitary display (display 14). In the untiled mode, panels 14P may be separated. The use of more than one size of panel 14P in system 10 of FIG. 10 may create a natural look (akin to picture frames) for panels 14P when panels 14P of FIG. 7 are separated during operation of system 10 in the untiled mode. This may enhance the appearance of system 10 in the untiled mode.

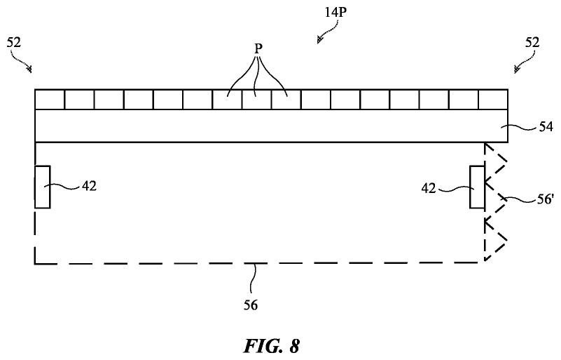

FIG. 8 is a cross-sectional side view of an illustrative display panel for system 10. As shown in FIG. 8, display panel 14P may have an array of pixels P. Pixels P may be arranged in a rectangular array or an array of other shapes. Panel 14P may be borderless or nearly borderless by minimizing or eliminating non-pixel structures along edges 52. During operation, pixels P may be used to display images on the front surface of panel 14P. Pixels 14P may be formed from thin-film transistor circuitry (e.g., thin-film organic light-emitting diode pixel circuitry) or other circuitry on substrate 54. Substrate 54 may be a printed circuit substrate formed from rigid printed circuit board material, may be a glass substrate, a substrate formed from other materials, and/or a substrate formed from a stack of layers of one or more different materials. Panel 14P may have a housing such as housing 56 that is formed from housing structures (e.g., housing walls) such as polymer housing walls, metal housing walls, and/or housing members formed from these materials and/or other suitable housing materials. In an illustrative configuration, components such as resources 42 of FIGS. 2 and 3 may be mounted within housing 56 (e.g., to support panel-to-panel alignment, panel-to-panel coupling, and/or panel-to-panel distribution of power and/or data signals). If desired, mechanical features may be formed in housing 56 that facilitate panel-to-panel alignment and/or panel-to-panel coupling. As shown in FIG. 8, for example, edge portion 56′ of housing 56 may have protrusions, recesses, and/or other alignment structures that are configured to mate with corresponding alignment structures on adjacent panels when panels 14P are coupled together to form display 14. When mated, the alignment structures may align joined panels with respect to each other.

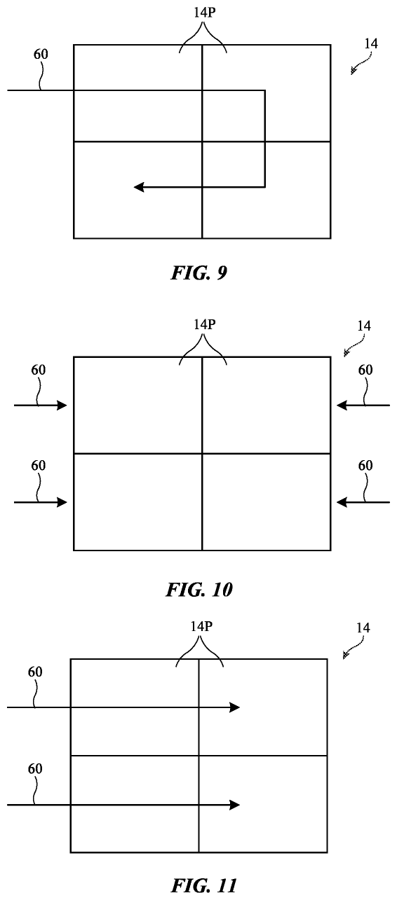

Signals such as power and/or data signals may be distributed to panels 14P from centralized equipment (e.g., a control unit that is separate from panels 14P) and/or from equipment that is included in one or more panels 14P. Illustrative signal distribution schemes for system 10 are shown in FIGS. 9, 10, and 11. These schemes may be use for distributing power signals and/or data signals (e.g., display data, touch sensor data, and/or other data distributed to the pixels and other circuitry of panels 14P and/or gathered from two-dimensional touch sensors, ambient light sensors, other sensors, and/or other circuitry of panels 14P). In the arrangement of FIG. 9, which may sometimes be referred to as a series signal path arrangement, signals are conveyed among panels in series along path 60. Path 60 of FIG. 9 passes through each panel 14P in display 14 in series. In the arrangement of FIG. 10, which may sometimes be referred to as a parallel signal path arrangement, signals are conveyed among panels 14P in parallel over parallel signal paths 60. FIG. 11 is a diagram of display 14 in an illustrative arrangement in which paths 60 are used to convey signals among panels 14P using both series and parallel techniques (sometimes referred to as a hybrid series-parallel configuration). In these illustrative examples, display data may be distributed to panels 14P in series, in parallel, or in a hybrid fashion and/or touch sensor data or other data from panels 14P may be collected in series, in parallel, or using a hybrid series-parallel arrangement. Series, parallel, and hybrid series-parallel schemes may also be used in distributing power signals among panels 14P. Signals may be distributed through the edges of panels 14P and/or through power and/or data connections on the rear of panels 14P (e.g., in configuration in which signal paths pass through plate 44).

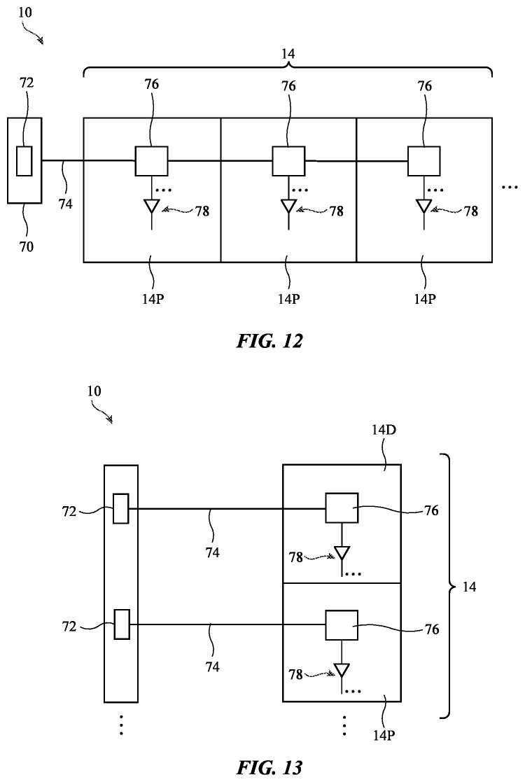

Illustrative circuitry for supporting series signal distribution is shown in FIG. 12. In the example of FIG. 12, data source 70 is separate from panels 14P. If desired, data source 70 may be included in one panel 14P or may be distributed among multiple panels 14P. Source 70 may produce display data (image data) or other suitable data. Source 70 may have a transmitter such as transmitter 72 that transmits data to display 14 via transmission line 74 or other signal path. Panels 14P may each have internal signal paths and a receiver and other circuitry (circuitry 76) that receives transmitted data and locally distributes a portion of the received data. Circuitry 76 in each panel 14P may, as an example, receive display data for that particular panel and drive the panel-specific image data onto data lines in the pixel array for that panel (see, e.g., illustrative display driver circuitry 78 in each panel 14P). Series data distribution schemes may also be used in gathering sensor data and other data from panels 14P (e.g., for control circuitry that is part of one or more panels 14P or for control circuitry that is housed in a separate unit). If desired, power may be distributed among panels 14P using a series path. The use of a series data path arrangement in the example of FIG. 12 is illustrative.

Illustrative circuitry for supporting parallel signal distribution is shown in FIG. 13. In this example, data source 70 (which may be separate from panels 14P or included in one or more of panels 14P) uses multiple transmitters 72 to transmit data in parallel over multiple respective transmission lines 74 or other suitable signal paths. This data is then received by respective receivers in panels 14P (see, e.g., circuitry 76) and supplied internally to the resource of each panel 14P (e.g., circuitry 78 in each panel may be used to drive data signals onto data lines associated with an array of pixels in each panel 14P). If desired, parallel signal schemes of the type shown in FIG. 13 may be used in gathering sensor data from panels 14P (e.g., for control circuitry housed in a separate unit or control circuitry housed in one or more of panels 14P). Parallel paths may also be used in distributing power among panels 14P of display 14 of FIG. 13. In some configurations, hybrid series-parallel schemes may be used for some or all of display 14, as described in connection with FIG. 11. The use of a parallel data path arrangement in the example of FIG. 13 is illustrative.

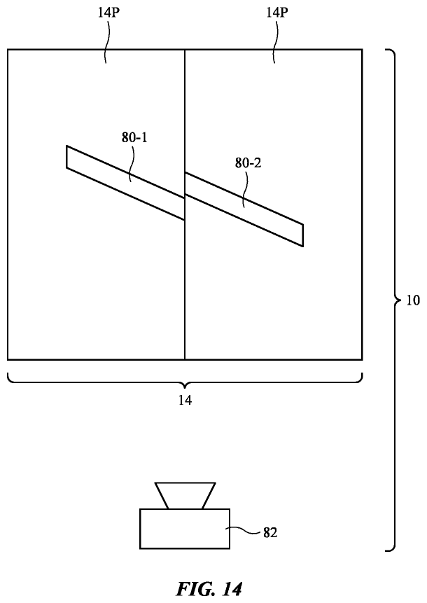

When panels 14P are attached to each other to form display 14, the images on adjacent panels may not initially be perfectly aligned. To help correct for image misalignment, system 10 may display test images on each panel 14P such as illustrative test images 80-1 and 80-2 of FIG. 14. These images can then be manually aligned by a user (e.g., by supplying user input to adjust the position of displayed image content using a remote control, a touch sensor, or other input device) or may be automatically aligned. Automatic alignment operations may, as an example, be performed by using a camera such as camera 82 to capture an image of display 14 while the test images are being displayed. Camera 82 may be include in a central unit that is part of system 10 and that is used in distributing image content to panels 14P or may be included in a separate electronic device (e.g., a cellular telephone or other portable electronic device). Control circuitry (e.g., control circuitry in system 10 or control circuitry in an external device) can then analyze the image of display 14 to determine whether test image content such as images 80-1 and 80-2 are misaligned with respect to each other. Corrective adjustments can then be made to each panel 14P to shift the position of the displayed image on each panel relative to the fixed pixel positions of that panel. In this way, display 14 can be digitally calibrated to remove the effects of physical panel misalignment that may arise when attaching panels 14P together to form display 14. Physical alignment operations may also be performed (e.g., using positioners 26), if desired.

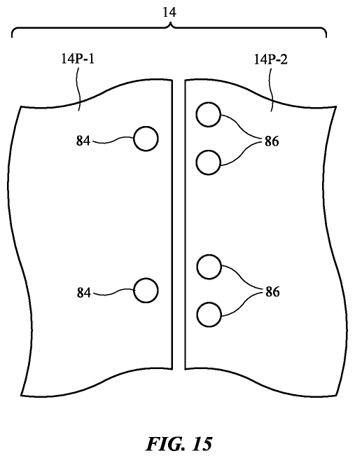

Another illustrative technique for aligning panels 14P in system 10 is shown in FIG. 15. As shown in FIG. 15, a first of the display panels 14P in system 10 such as first panel 14P-1 may have one or more light sources such as light sources 84. Light sources 84 may be dedicated light-emitting diodes or lasers or may each include one or more pixels from the array of pixels that are normally used in displaying image content. Each light source 84 may emit light (e.g., light characterized by a predetermined color, intensity, time-varying pattern, and/or location). The emitted light from sources 84 may be detected by light sensing circuitry in an adjacent panel in system 10 such as second panel 14P-2 in display 14 of FIG. 15. Detectors 86 in panel 14P-2 may, for example, be located along the edge of panel 14P-2 that faces first panel 14P-1 so that detectors 86 may detect light emitted by light sources 84 in first panel 14P-1 after panels 14P have been moved together to form display 14. Light sources 84 and detectors 86 may be evenly or unevenly spaced along respective edges of panels 14P-1 and 14P-2, respectively. In the illustrative configuration of FIG. 15, there are a pair of light detectors 86 located on opposing sides of each source 84 (e.g., slightly above and slightly below each source 84 in the orientation of FIG. 15). When panels 14P-1 and 14P-2 are misaligned, the readings of detectors 86 will reveal the direction and amount of misalignment between the panels. For example, if panel 14P-2 is too high relative to panel 14P-1, the lower detector 86 of each pair of detectors 86 will measure more emitted light than the upper detector 86 of each pair of detectors 86. Schemes in which sources 84 encode their identity (e.g., using emitted light color, modulation pattern, etc.) may help system 10 correctly identify misalignment direction and amount. In general, any suitable number of sources 84 may be provided, any suitable pattern and number of detectors 86 may be provided, and any suitable scheme may be used to ensure that misalignment is measured. If desired, magnetic sensors that detect the presence of magnetic fields from magnets in adjacent panels and/or other sensors may be used instead of light detectors and/or in combination with light detectors to measure alignment. In response to measuring misalignment between panels, the control circuitry of system 10 may take suitable action (e.g., by using positioners 26 to adjust the positions of one or more panels 14P, thereby aligning panels 14P as desired, by controlling panels 14P to digitally adjust image position as described in connection with FIG. 14, etc.).

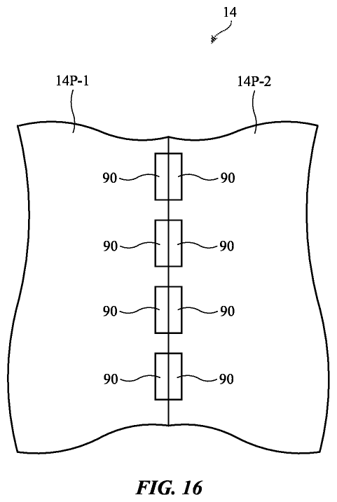

As shown in FIG. 16, the edges of panels 14 may be provided with one or more components 90. Components 90 may include resources 42 of FIG. 3 such as components for distributing power and data (e.g., power supply circuits, power receiving circuits, wireless power components, data transmitters, data receivers, and/or other circuits for transmitting and/or receiving power and/or data). In some configurations, components 90 may include electrical connectors (e.g., connectors for making ohmic contact with mating connectors, electrodes that form electrical connections by capacitive coupling, and/or other connectors). Optical connectors have mating light sources and detectors that can serve as optical transmitters and receivers for carrying data optically between panels 14P.

Components 90 may include sensors 16. Sensors 16 may include light detectors (e.g., photodetectors, cameras, and/or other light sensing circuitry) that can detect light from light sources in an adjacent panel and thereby measure misalignment (e.g., by measuring relative position) between panels 14P. Sensors 16 in components 90 may also include capacitive sensors, magnetic sensors, force sensors, and/or other sensors that can be used in measuring misalignment).

In some configurations, components 90 may include components for facilitating alignment and/or coupling between panels 14P. Components 90 may, for example, include magnets (e.g., permanent magnets). As an example, a first panel may have a magnet with an outwardly facing north pole and a second panel may have a magnet with an outwardly facing south pole. The magnets in the first and second panels may face each other so that the poles of the magnets attract the panels towards each other (e.g., the north pole of the magnet in the first panel may face to the right to attract the south pole of the magnet in the second panel, which may face to the left). Magnetic coupling forces between the magnets in adjacent panels may be sufficient to hold the panels of display 14 together during use.

By providing one or more magnets along each of the edges of display panels 14P, panels 14P may be magnetically aligned with respect to each other and magnetically attracted towards each other when panels 14P are brought into the vicinity of each other (e.g., by positioners 26). The magnets help align adjacent panels by resisting lateral shifting of the panels with respect to each other that could cause the images on the panels to become misaligned. Multi-pole magnet configurations (e.g., magnets having multiple magnetic poles of various different sizes and/or polarities along the panel edges) may exhibit enhanced resistance to misalignment (e.g., the magnetic repulsive force created by laterally misaligning opposing sets of magnetic poles in a pair of panels 14P may be larger than in magnet configurations with only a single magnetic pole on each edge). If desired, additional alignment structures may be used (e.g., physical alignment structures such as the illustrative alignment structures of edge portion 56′ of FIG. 8). In general, magnetic coupling and/or alignment structures may be used in any suitable combination with other coupling and/or alignment structures.

In addition to incorporating magnets into one or more of components 90, components 90 may include structures and/or devices that facilitate the transfer of power and/or data. For example, components 90 may include mating contacts (spring contacts, contact pads, contact pins, metal tabs, etc.), may include transmitters (optical signal transmitters with light sources that emit light, electrical signal transmitters that output electrical signals, etc.), may include receivers (e.g., optical signal receivers with light detectors such as photodetectors, electrical signal detectors, etc.), may include power circuits, may include electrodes that are capacitively coupled to electrodes on adjacent panels, and/or other components for transmitting information and/or power between panels 14P (e.g., using signal paths such as signal paths 60 of FIGS. 9, 10, and/or 11).

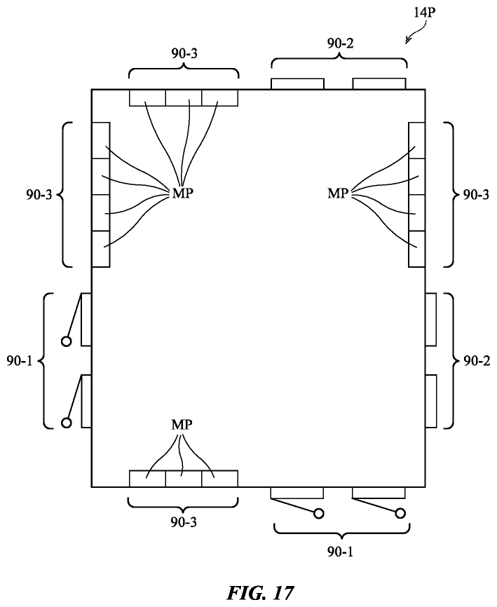

FIG. 17 is a front view of an illustrative panel 14 showing different types of components 90 that may be included along one or more of the edges of each panel 14P. In the example of FIG. 14, panel 14P has components on each of its four edges. Configurations in which fewer than four of the edges of panel 14P are provided with components may be used, if desired. As shown in FIG. 17, display panels in display 14 may include contacts such as spring contacts 90-1 and mating contact pads 90-2. When panels 14P are placed adjacent to each other to operate system 10 in a tiled mode, the spring contacts or other contacts on a first of the panels form electrical connection with respective pads or other contacts on a second of the panels. Panels such as panel 14P of FIG. 17 may also have magnets (e.g., multipole magnets for alignment and/or coupling) such as magnets 90-3 having magnetic poles MP (e.g., north and/or south poles arranged in patterns to facilitate alignment). When panels 14P are placed adjacent to each other, the magnets on a first of the panels attract corresponding magnets on a second of the panels to help align the panels laterally with respect to each other while holding the edges of the panels together to form display 14.

If desired, magnets such as magnets 90-3 may be placed on a wall or other support structure (see, e.g., support structure 40 of FIG. 3, or plate 44 of FIG. 44). The magnets on the wall or other support structure may then be used to align panels 14P with respect to each other when panels 14P are attached to each other to operate in the tiled display mode.

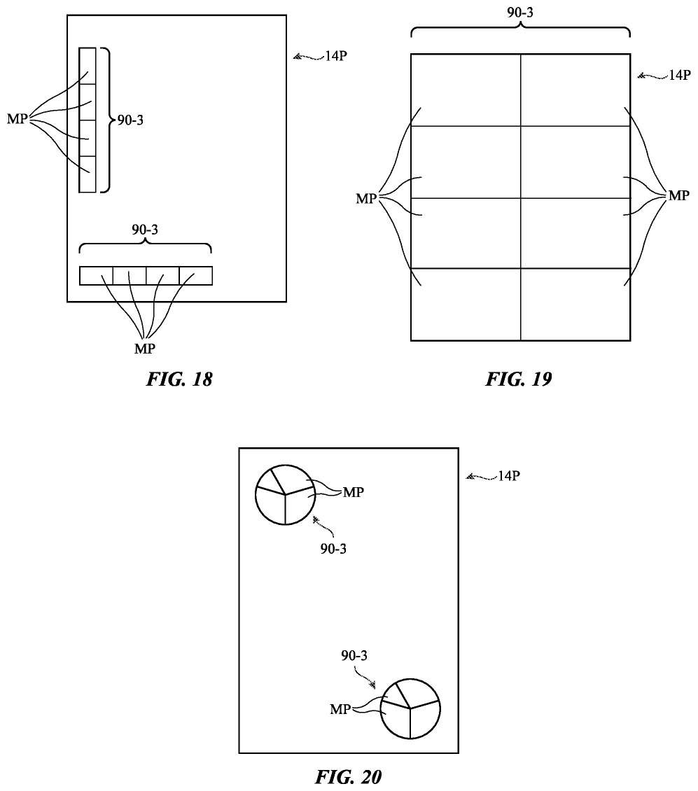

FIGS. 18, 19, and 20 are examples of illustrative configurations for panels 14P in which magnets 90-3 of panels 14P are formed on the rear of panels 14P to attach to corresponding magnets on a wall, mounting plate, or other support structure behind panels 14P. In the example of FIG. 18, magnets 90-3 are formed in one or more strips along the rear side of each panel. In the example of FIG. 19, most or all of the rear surface of panel 14P has been covered with magnets (e.g., a set of magnets 90-3 with different poles MP covers the rear of panel 14P). FIG. 20 shows how magnets 90-3 may have disk shapes (each of which may have multiple magnetic poles MP). Other arrangements may be used, if desired. The magnet mounting arrangements of FIGS. 18, 19, and 20 are illustrative.

Magnets may be formed from magnetic material (e.g., ferrite particles, etc.) that are embedded in polymer binder. It may be desirable, in some configurations, to provide magnets with electrical conductivity (e.g., so that magnets can serve as electrical contacts). In an illustrative configuration, electrically conductive magnets may be formed by incorporating particles of magnetic material and particles of conductive material such as metal particles into a polymer binder. In this type of arrangement, the magnetic material can be magnetized to form a permanent magnet and the metal particles (or other conductive particles) can provide the magnet with a desired electrical conductivity.

Electrically conductive magnets such as these may therefore serve both as magnets 90-3 and as electrical contacts (e.g., electrodes or other contact pads such as contact pads 90-2 on the edges of panel 14P in FIG. 17, electrodes or other contacts pads on the rear of panel 14P as shown by magnets 90-3 in FIGS. 18, 19, and 20, etc.). When the magnets of one panel are coupled to the magnets of an adjacent panel (or the magnets of a support structure), power signals and/or data signals may be supplied through the magnets. As an example, direct-current power for panels 14P may be supplied from an alternating-current-to-direct-current power adapter that is coupled to a support structure such as plate 44 of FIG. 4. Plate 44 may have magnets formed from conductive material that receives the direct-current power from the power adapter. Direct-current (DC) power from plate 44 may then be distributed from plate 44 to each of the panels coupled to plate 44 through the magnets of plate 44 and the mating magnets of panels 14P. In another illustrative configuration, magnets that have been coupled to each other along the edges of panels 14P may be used to serve as electrical contacts that carry power and/or data signals between panels.

The foregoing is merely illustrative and various modifications can be made to the described embodiments. The foregoing embodiments may be implemented individually or in any combination.

What is claimed is:

1. A tiling display system, comprising:
display panels;
control circuitry configured to supply image data to the display panels; and
electrically controlled positioners each of which is coupled to a respective one of the plurality of display panels, wherein display panels are positioned by the electrically controlled positioners in response to commands from the control circuitry and are configured to operate in:
a) an untiled mode in which the display panels are separated from each other by the electrically controlled positioners; and
b) a tiled mode in which the display panels are attached to each other by the electrically controlled positioners and form a tiled display on which an image is displayed.

2. The tiling display system defined in claim 1 wherein each display panel has edge contacts that mate with edge contacts of an adjacent one of the display panels in the tiled mode.

3. The tiling display system defined in claim 2 wherein the contacts include spring contacts and contact pads.

4. The tiling display system defined in claim 3 wherein a first of the display panels includes at least one of the spring contacts along a first edge of the first display panel, wherein a second of the display panels includes at least one of the contact pads along a second edge of the second display panel, and wherein in the tiled mode the spring contact on the first edge forms an electrical connection with the contact pad on the second edge.

5. The tiling display system defined in claim 2 wherein the edge contacts include an electrically conductive magnet.

6. The tiling display system defined in claim 1 further comprising magnets along edges of the display panels that are configured to align the display panels with respect to each other in the tiled mode.

7. The tiling display system defined in claim 1 further comprising alignment structures along edges of the display panels that are configured to align the display panels with respect to each other in the tiled mode.

8. The ting display system defined in claim 1 further comprising magnets on rear surfaces of the display panels.

9. The tiling display system defined in claim 1 wherein the display panels comprises magnets configured to receive power.

10. the tiling display system defined in claim 1 wherein a series signal path is formed through the display panels in the tiled mode.

11. The tiling display system defined in claim 10 wherein the series signal path is configured to distribute the image data to the display panels.

12. The tiling display system defined in claim 10 wherein the series signal path is configured to convey sensor data between the display panels.

13. The tiling display system defined in claim 1 wherein multiple parallel signal paths are formed through the display panels in the tiled mode.

14. The tiling display system defined in claim 13 wherein the multiple parallel signal paths are configured to convey the image data to the display panels.

15. The tiling display system defined in claim 13 wherein the multiple parallel signal paths are configured to convey sensor data between the display panels.

16. The tiling display system defined in claim 1 wherein the positioners are configured to mount to a wall and are configured to move the display panels relative to the wall.

17. The tiling display system defined in claim 1 further comprising a support structure that is configured to mount to a wall, wherein the positioners are each coupled to the support structure.

18. The tiling display system defined in claim 1 wherein the display panels include first display panels and second display panels and wherein the first and second display panels have different sizes.

19. the tiling display system defined in claim 1 wherein a first of the display panels is configured to emit light and wherein a second of the display panels has a sensor configured to measure the emitted light in the tiled mode.

20. The tiling display system defined in claim 19 wherein the control circuitry is configured to measure alignment between the first and second display panels using the measured emitted light.

21. The tiling display system defined in claim 1 wherein at least one of the display panels comprises a plurality of light detectors to measure alignment between adjacent display panels.

22. The tiling display system defined in claim 1 wherein at least one of the display panels comprises a light source configured to transmit data signals and wherein at least one of the display panels comprises a light detector configured to detect the transmitted data signals.

23. A display system, comprising:
display panels configured to operate in:
a) an untiled mode in which the display panels are separated and display independent content;
b) a tiled mode in which the display panels are joined together to form a display that displays an image across all of the display panels; and
electrical contacts and magnets along the edges of the display panels.

24. The display system defined in claim 23 wherein the display panels comprise display panels of different shapes.

25. A display system comprising:
display panels including display panels of different sizes; and
positioners coupled to the display panels, wherein the positioners are configured to:
place the display panels apart during operation in an untiled mode in which each display panel forms a separate display; and
place the display panels together during operation in a tiled mode in which the display panels form a single tiled display.

26. The display system defined in claim 25 wherein at least some of the display panels comprise sensors configured to measure display panel misalignment in the tiled mode.

27. The display system defined in claim 25 further comprising a camera configured to measure test content on the display panels in the tiled mode.

28. the display system defined in claim 27 further comprising control circuitry configured to align image content on the display panels based on the measured test content.
